(19) United States
(12) Patent Application Publication
(10) Pub. No.: US 2016/0028144 A1
(43) Pub. Date: Jan. 28, 2016

(54) DIRECTIONAL COUPLER

(71) Applicant: Murata Manufacturing Co., Ltd., Kyoto (JP)

(72) Inventors: Keisuke Katabuchi, Kyoto (JP); Tetsuo Taniguchi, Kyoto (JP); Yasushi Yunoki, Kyoto (JP)

(21) Appl. No.: 14/795,217

(22) Filed: Jul. 9, 2015

(30) Foreign Application Priority Data
Jul. 23, 2014 (JP) 2014-149704

(51) Int. Cl. H01P 5/18

(52) U.S. Cl. CPC H01P 5/184

(57) ABSTRACT

A directional coupler includes a main line, a sub line, and a parasitic element. The main line includes first and second main line portions formed substantially in a spiral shape, as viewed from a first direction. The second main line portion is positioned in a second direction which is perpendicular to the first direction, as viewed from the first direction. The sub line includes first and second sub line portions formed substantially in a spiral shape, as viewed from the first direction. The first and second sub line portions are electromagnetically coupled with the first and second main line portions, respectively. The second sub line portion is positioned in the second direction, as viewed from the first direction. The parasitic element is superposed on the first main line portion and the second sub line portion, as viewed from the first direction.

### BACKGROUND OF THE DISCLOSURE

1. Field of the Disclosure

The present disclosure relates to a directional coupler, and more particularly, to a directional coupler including a main line and a sub line electromagnetically coupled with each other.

2. Description of the Related Art

As an example of directional couplers of the related art, the directional coupler disclosed in Japanese Patent No. 3203253 is known. This directional coupler includes first and second coupling lines formed in a spiral shape. The first and second coupling lines are superposed on each other in the vertical (top-bottom) direction and are electromagnetically coupled with each other. With this configuration, the first coupling line serves as a main line, while the second coupling line serves as a sub line.

In the directional coupler disclosed in this publication, it is desired that the degree of coupling between the first coupling line (main line) and the second coupling line (sub line) be increased.

### BRIEF SUMMARY OF THE DISCLOSURE

Accordingly, it is an object of the present disclosure to provide a directional coupler in which the degree of coupling between a main line and a sub line can be increased.

According to preferred embodiments of the present disclosure, there is provided a directional coupler including a main line, a sub line, and a parasitic element. The main line includes first and second main line portions formed substantially in a spiral shape, as viewed from a first direction. The second main line portion is positioned in a second direction which is perpendicular to the first direction, as viewed from the first direction. The sub line includes first and second sub line portions formed substantially in a spiral shape, as viewed from the first direction. The first and second sub line portions are electromagnetically coupled with the first and second main line portions, respectively. The second sub line portion is positioned in the second direction, as viewed from the first direction. The parasitic element is superposed on the first main line portion and the second sub line portion, as viewed from the first direction.

According to the preferred embodiments of the present disclosure, it is possible to increase the degree of coupling between a main line and a sub line of a directional coupler.

Other features, elements, characteristics and advantages of the present disclosure will become more apparent from the following detailed description of the preferred embodiments of the present disclosure with reference to the attached drawings.

### BRIEF DESCRIPTION OF THE SEVERAL VIEWS OF THE DRAWINGS

FIG. 1 is an equivalent circuit diagram of a directional coupler;

FIG. 2 is an external perspective view of a directional coupler;

FIG. 3 is an exploded perspective view of a multilayer body of a directional coupler according to a first embodiment;

FIG. 4 is a graph illustrating simulation results of a first model and a second model;

FIG. 5 is an exploded perspective view of a multilayer body of a directional coupler according to a second embodiment;

FIG. 6 is an exploded perspective view of a multilayer body of a directional coupler according to a third embodiment;

FIG. 7 is an exploded perspective view of a multilayer body of a directional coupler according to a fourth embodiment; and

FIG. 8 is an exploded perspective view of a multilayer body of a directional coupler according to a fifth embodiment.

### DETAILED DESCRIPTION OF THE DISCLOSURE

### First Embodiment

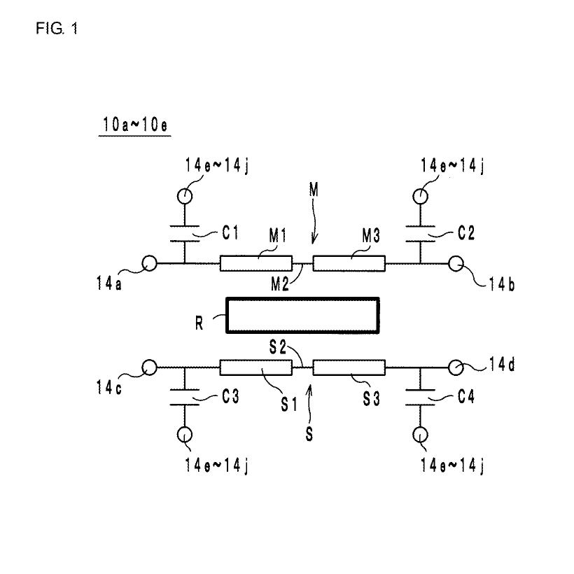

A directional coupler 10a according to a first embodiment will be described below with reference to FIGS. 1 through 4. FIG. 1 is an equivalent circuit diagram of each of directional couplers 10a through 10e.

The circuit configuration of the directional coupler 10a will be described. The directional coupler 10a is used in a predetermined frequency band, for example, a frequency band (for example, 698 to 3800 MHz) in which long term evolution (LTE) is used.

As the circuit configuration, the directional coupler 10a includes outer electrodes 14a through 14j, a main line M, a sub line S, capacitors C1 through C4, and a ring conductor R. The main line M is connected between the outer electrodes 14a and 14b and includes main line portions M1 and M3 and an intermediate line portion M2. The main line portion M1, the intermediate line portion M2, and the main line portion M3 are connected in series with each other in this order between the outer electrodes 14a and 14b.

The sub line S is connected between the outer electrodes 14c and 14d and includes sub line portions S1 and S3 and an intermediate line portion S2. The sub line portion S1, the intermediate line portion S2, and the sub line portion S3 are connected in series with each other in this order between the outer electrodes 14c and 14d.

The main line portion M1 and the sub line portion S1 are electromagnetically coupled with each other. The main line portion M3 and the sub line portion S3 are also electromagnetically coupled with each other.

The capacitor C1 is connected between the outer electrode 14a and the outer electrodes 14e through 14j. The capacitor C2 is connected between the outer electrode 14b and the outer electrodes 14e through 14j. The capacitor C3 is connected between the outer electrode 14c and the outer electrodes 14e through 14j. The capacitor C4 is connected between the outer electrode 14d and the outer electrodes 14e through 14j.

The ring conductor R is a ring-shaped conductor layer and is superposed on the main line portions M1 and M3 and the sub line portions S1 and S3. Since the ring conductor R is a parasitic element, the potential of the ring conductor R is stray potential. The ring conductor R is disposed between the main line portion M1 and the sub line portion S1 and between the main line portion M3 and the sub line portion S3. With this configuration, the ring conductor R serves to increase the degree of coupling between the main line M and the sub line S.

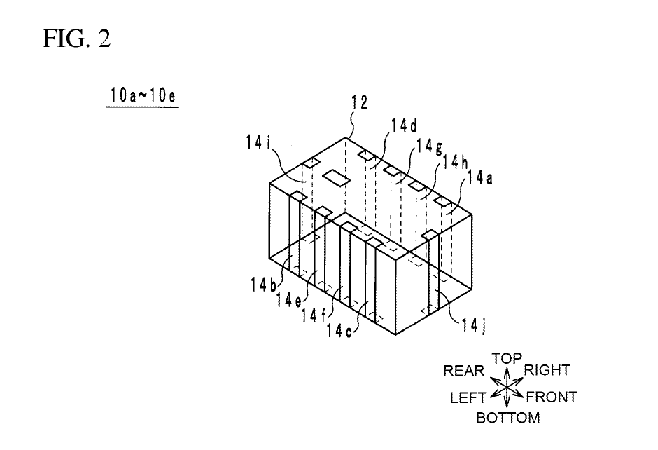

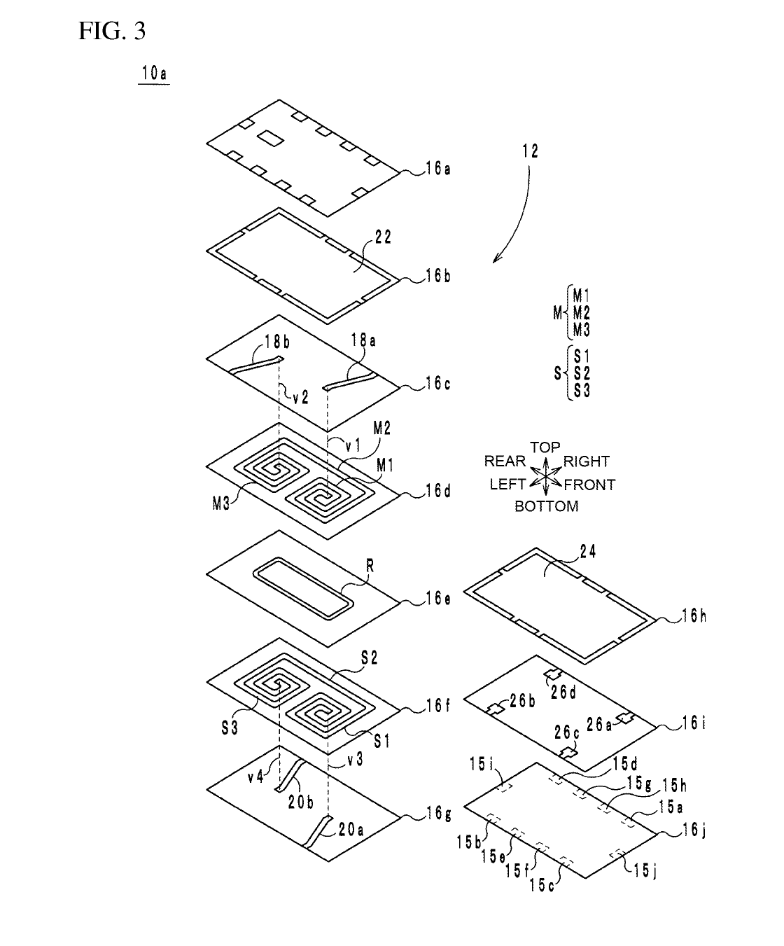

In the directional coupler 10a configured as described above, the outer electrode 14a is used as an input port, while the outer electrode 14b is used as an output port. The outer electrode 14c is used as a coupling port. The outer electrode 14d is used as a terminate port which is terminated at about 50Ω. The outer electrodes 14e through 14j are used as ground ports which are grounded. When a high-frequency signal is input into the outer electrode 14a, it is output from the outer electrode 14b. Since the main line M and the sub line S are electromagnetically coupled with each other, a high-frequency signal having a power proportional to the power of a high-frequency signal output from the outer electrode 14b is output from the outer electrode 14c. An example of the specific configuration of the directional coupler 10a according to the first embodiment will be discussed below with reference to FIGS. 2 and 3. FIG. 2 is an external perspective view of each of the directional couplers 10a through 10e. FIG. 3 is an exploded perspective view of a multilayer body 12 of the directional coupler 10a. Hereinafter, the stacking direction of the multilayer body 12 is defined as the top-bottom direction, the longitudinal direction of the directional coupler 10a, as viewed from above, is defined as the front-rear direction, and the widthwise direction of the directional coupler 10a, as viewed from above, is defined as the right-left direction.

As shown in FIGS. 2 and 3, the directional coupler 10a includes a multilayer body 12, outer electrodes 14a through 14j, a main line M, a sub line S, a ring conductor R, extended conductors 18a, 18b, 20a, and 20b, ground conductors 22 and 24, capacitor conductors 26a through 26d, and via-hole conductors v1 through v4.

The multilayer body 12 is formed substantially in a rectangular parallelepiped, as shown in FIG. 2, and is formed by stacking substantially rectangular dielectric layers 16a through 16j made of dielectric ceramic on each other from the top to the bottom in this order, as shown in FIG. 3. Hereinafter, the top and bottom principal surfaces of the multilayer body 12 will be respectively referred to as the “top surface” and the “bottom surface”, the front and rear end surfaces of the multilayer body 12 will be respectively referred to as the “front surface” and the “rear surface”, and the right and left side surfaces of the multilayer body 12 will be respectively referred to as the “right surface” and the “left surface”. When the directional coupler 10a is mounted on a circuit board, the bottom surface of the multilayer body 12 is used as a mount surface opposing the circuit board. The top surfaces of the dielectric layers 16a through 16j will be referred to as the “front sides”, and the bottom surfaces of the dielectric layers 16a through 16j will be referred to as the “back sides”.

The outer electrodes 14b, 14e, 14f, and 14c are disposed on the left surface of the multilayer body 12 from the rear to the front in this order. The outer electrodes 14b, 14e, 14f, and 14c extend on the left surface in the top-bottom direction and also bend to the top and bottom surfaces.

The outer electrodes 14d, 14g, 14h, and 14a are disposed on the right surface of the multilayer body 12 from the rear to the front in this order. The outer electrodes 14d, 14g, 14h, and 14a extend on the right surface in the top-bottom direction and also bend to the top and bottom surfaces.

The outer electrode 14i extends on the rear surface of the multilayer body 12 in the top-bottom direction and also bends to the top and bottom surfaces. The outer electrode 14j extends on the front surface of the multilayer body 12 in the top-bottom direction and also bends to the top and bottom surfaces.

The main line M is disposed within the multilayer body 12 and includes main line portions M1 and M3 and an intermediate line portion M2. The main line portion M1 is a linear conductor layer disposed on the front half of the front side of the dielectric layer 16d. The main line portion M1 is a spiral conductor layer which winds counterclockwise through multiple turns from the start point positioned at the center of the front half of the dielectric layer 16d to the terminate point positioned near the right front corner of the dielectric layer 16d, as viewed from above. Hereinafter, the start point and the terminate point of the main line portion M1 will be respectively referred to as the “upstream end” and the “downstream end”. The center of the main line portion M1 is the upstream end of the main line portion M1. Accordingly, the main line portion M1 is formed in a spiral shape moving farther away from the center point while winding around the center point counterclockwise.

The main line portion M3 is a linear conductor layer disposed on the rear half of the front side of the dielectric layer 16d. Accordingly, the main line portion M3 is disposed at the rear of the main line portion M1, as viewed from above. The main line portion M3 is a spiral conductor layer which winds counterclockwise through multiple turns from the start point positioned near the right rear corner of the dielectric layer 16d to the terminate point positioned at the center of the rear half of the dielectric layer 16d, as viewed from above. Hereinafter, the start point and the terminate point of the main line portion M3 will be respectively referred to as the “upstream end” and the “downstream end”. The center of the main line portion M3 is the downstream end of the main line portion M3. Accordingly, the main line portion M3 is formed in a spiral shape moving closer to the center point while winding around the center point counterclockwise.

The main line portions M1 and M3 configured as described above are line-symmetrical with each other about a straight line passing through the center of the dielectric layer 16d and extending in the right-left direction.

The intermediate line portion M2 is a linear conductor layer disposed on the front side of the dielectric layer 16d. The intermediate line portion M2 connects the downstream end of the main line portion M1 and the upstream end of the main line portion M3 and extends along the right long side of the dielectric layer 16d. That is, the intermediate line portion M2 is connected between the first and third main line portions M1 and M3. Accordingly, the main line portions M1 and M3 are electrically connected in series with each other. The main line portions M1 and M3 and the intermediate line portion M2 are formed by applying a conductive paste made of a metal, that is, Cu or Ag, as the main component to the front side of the dielectric layer 16d.

The extended conductor 18a is a straight linear conductor layer disposed on a higher level than the main line M in the top-bottom direction, and more specifically, on the front side of the dielectric layer 16c. One end portion of the extended conductor 18a is superposed on the upstream end of the main line portion M1, as viewed from above. The other end portion of the extended conductor 18a extends to the right long side of the dielectric layer 16c and is connected to the outer electrode 14a.

The via-hole conductor v1 passes through the dielectric layer 16c in the top-bottom direction and connects the end portion of the extended conductor 18a superposed on the upstream end of the main line portion Ml and the upstream end of the main line portion M1.

The extended conductor 18b is a straight linear conductor layer disposed on a higher level than the main line M in the top-bottom direction, and more specifically, on the front side of the dielectric layer 16c. One end portion of the extended conductor 18b is superposed on the downstream end of the main line portion M3, as viewed from above. The other end portion of the extended conductor 18b extends to the left long side of the dielectric layer 16c and is connected to the outer electrode 14b.

The extended conductor 18b has substantially the same configuration as the extended conductor 18a. More specifically, if the extended conductor 18b is rotated by 180° around the center of the dielectric layer 16c, it coincides with the extended conductor 18a. That is, the extended conductors 18a and 18b are point-symmetrical with each other about the center of the dielectric layer 16c.

The via-hole conductor v2 passes through the dielectric layer 16c in the top-bottom direction and connects the end portion of the extended conductor 18b superposed on the downstream end of the main line portion M3 and the downstream end of the main line portion M3. With this configuration, the main line M is connected between the outer electrodes 14a and 14b. The via-hole conductors v1 and v2 are formed by charging a conductive paste made of a metal, that is, Cu or Ag, as the main component into via-holes formed in the dielectric layer 16c.

The sub line S is disposed within the multilayer body 12 and includes sub line portions S1 and S3 and an intermediate line portion S2. The sub line S has substantially the same configuration as the main line M, and the sub line S and the main line M are superposed on each other and coincides with each other, as viewed from above.

The sub line portion S1 is a linear conductor layer disposed on the front half of the front side of the dielectric layer 16f. The sub line portion S1 is a spiral conductor layer which winds counterclockwise through multiple turns from the start point positioned at the center of the front half of the dielectric layer 16f to the terminate point positioned near the right front corner of the dielectric layer 16f, as viewed from above. Hereinafter, the start point and the terminate point of the sub line portion S1 will be respectively referred to as the “upstream end” and the “downstream end”. The center of the sub line portion S1 is the upstream end of the sub line portion S1. Accordingly, the sub line portion S1 is formed in a spiral shape moving farther away from the center point while winding around the center point counterclockwise.

The sub line portion S3 is a linear conductor layer disposed on the rear half of the front side of the dielectric layer 16f. Accordingly, the sub line portion S3 is disposed at the rear of the sub line portion S1, as viewed from above. The sub line portion S3 is a spiral conductor layer which winds counterclockwise through multiple turns from the start point positioned near the right rear corner of the dielectric layer 16f to the terminate point positioned at the center of the rear half of the dielectric layer 16f, as viewed from above. Hereinafter, the start point and the terminate point of the sub line portion S3 will be respectively referred to as the “upstream end” and the “downstream end”. The center of the sub line portion S3 is the downstream end of the sub line portion S3. Accordingly, the sub line portion S3 is formed in a spiral shape moving closer to the center point while winding around the center point counterclockwise.

The sub line portions S1 and S3 configured as described above are line-symmetrical with each other about a straight line passing through the center of the dielectric layer 16f and extending in the right-left direction. The intermediate line portion S2 is a linear conductor layer disposed on the front side of the dielectric layer 16f. The intermediate line portion S2 connects the downstream end of the sub line portion S1 and the upstream end of the sub line portion S3 and extends along the right long side of the dielectric layer 16f. That is, the intermediate line portion S2 is connected between the first and third sub line portions S1 and S3. Accordingly, the sub line portions S1 and S3 are electrically connected in series with each other. The sub line portions S1 and S3 and the intermediate line portion S2 are formed by applying a conductive paste made of a metal, that is, Cu or Ag, as the main component to the front side of the dielectric layer 16f.

The extended conductor 20a is a straight linear conductor layer disposed on a lower level than the sub line S in the top-bottom direction, and more specifically, on the front side of the dielectric layer 16g. One end portion of the extended conductor 20a is superposed on the upstream end of the sub line portion S1, as viewed from above. The other end portion of the extended conductor 20a extends to the left long side of the dielectric layer 16g and is connected to the outer electrode 14c. The extended conductor 20a has substantially the same length as the extended conductor 18a.

The via-hole conductor v3 passes through the dielectric layer 16f in the top-bottom direction and connects the end portion of the extended conductor 20a superposed on the upstream end of the sub line portion S1 and the upstream end of the sub line portion S1.

The extended conductor 20b is a straight linear conductor layer disposed on a lower level than the sub line S in the top-bottom direction, and more specifically, on the front side of the dielectric layer 16g. One end portion of the extended conductor 20b is superposed on the downstream end of the sub line portion S3, as viewed from above. The other end portion of the extended conductor 20b extends to the right long side of the dielectric layer 16g and is connected to the outer electrode 14d. The extended conductor 20b has substantially the same length as the extended conductor 18b.

The extended conductor 20b has substantially the same configuration as the extended conductor 20a. More specifically, if the extended conductor 20b is rotated by 180° around the center of the dielectric layer 16g, it coincides with the extended conductor 20a. That is, the extended conductors 20a and 20b are point-symmetrical with each other about the center of the dielectric layer 16g. The extended conductors 18a, 18b, 20a, and 20b are formed by applying a conductive paste made of a metal, that is, Cu or Ag, as the main component to the front sides of the dielectric layers 16c and 16g.

The via-hole conductor v4 passes through the dielectric layer 16f in the top-bottom direction and connects the end portion of the extended conductor 20b superposed on the downstream end of the sub line portion S3 and the downstream end of the sub line portion S3. With this configuration, the sub line S is connected between the outer electrodes 14c and 14d. The via-hole conductors v3 and v4 are formed by charging a conductive paste made of a metal, that is, Cu or Ag, as the main component into via-holes formed in the dielectric layer 16f.

The ring conductor R is disposed on the dielectric layer 16e, and is a conductor layer formed substantially in a ring-like shape, as viewed from above. The ring conductor R is superposed on the main line portions M1 and M3 and the sub line portions S1 and S3. In the first embodiment, the ring conductor R is formed substantially in a rectangle longitudinally extending in the front-rear direction, as viewed from above. The centers of the main line portions M1 and M3 and the centers of the sub line portions S1 and S3 are positioned within the region surrounded by the ring conductor R, as viewed from above. Since the ring conductor R is a parasitic element, it is not connected to other conductors. The ring conductor R is disposed between the main line portion M1 and the sub line portion S1 and between the main line portion M3 and the sub line portion S3 in the top-bottom direction.

The ground conductor 22 is disposed within the multilayer body 12, and is located on a higher level than the main line M, the sub line S, the ring conductor R, and the extended conductors 18a, 18b, 20a, and 20b in the top-bottom direction. More specifically, the ground conductor 22 is formed substantially in a rectangular shape and is disposed such that it covers substantially the entire surface of the front side of the dielectric layer 16b. The ground conductor 22 extends to the individual sides of the dielectric layer 16b and is connected to the outer electrodes 14e through 14j.

The ground conductor 24 is disposed within the multilayer body 12 and is located on a lower level than the main line M, the sub line S, the ring conductor R, and the extended conductors 18a, 18b, 20a, and 20b in the top-bottom direction. More specifically, the ground conductor 24 is formed substantially in a rectangular shape and is disposed such that it covers substantially the entire surface of the front side of the dielectric layer 16h. The ground conductor 24 extends to the individual sides of the dielectric layer 16h and is connected to the outer electrodes 14e through 14j. The ground conductors 22 and 24 are formed by applying a conductive paste made of a metal, that is, Cu or Ag, as the main component to the front sides of the dielectric layers 16b and 16h, respectively.

The capacitor conductors 26a through 26d are disposed within the multilayer body 12 and are located on a lower level than the ground conductor 24 in the top-bottom direction. More specifically, the capacitor conductors 26a through 26d are substantially rectangular conductor layers disposed on the front side of the dielectric layer 16i. The capacitor conductor 26a extends to the right long side of the dielectric layer 16i and is connected to the outer electrode 14a. The capacitor conductor 26a opposes the ground conductor 24 with the dielectric layer 16h therebetween so as to form a capacitor C1. With this configuration, the capacitor C1 is connected between the outer electrode 14a and the outer electrodes 14e through 14j.

The capacitor conductor 26b extends to the left long side of the dielectric layer 16i and is connected to the outer electrode 14b. The capacitor conductor 26b opposes the ground conductor 24 with the dielectric layer 16h therebetween so as to form a capacitor C2. With this configuration, the capacitor C2 is connected between the outer electrode 14b and the outer electrodes 14e through 14j.

The capacitor conductor 26c extends to the left long side of the dielectric layer 16i and is connected to the outer electrode 14c. The capacitor conductor 26c opposes the ground conductor 24 with the dielectric layer 16h therebetween so as to form a capacitor C3. With this configuration, the capacitor C3 is connected between the outer electrode 14c and the outer electrodes 14e through 14j.

The capacitor conductor 26d extends to the right long side of the dielectric layer 16i and is connected to the outer electrode 14d. The capacitor conductor 26d opposes the ground conductor 24 with the dielectric layer 16h therebetween so as to form a capacitor C4. With this configuration, the capacitor C4 is connected between the outer electrode 14d and the outer electrodes 14e through 14j. The capacitor conductors 26a through 26d are formed by applying a conductive paste made of a metal, that is, Cu or Ag, as the main component to the front side of the dielectric layer 16i.

### Advantages

By the use of the directional coupler 10a configured as described above, it is possible to increase the degree of coupling between the main line M and the sub line S. This will be discussed more specifically. The directional coupler 10a includes the ring conductor R. The ring conductor R is superposed on the main line portions M1 and M3 and the sub line portions S1 and S3, as viewed from above. With this configuration, a capacitor is formed between the main line portion M1 and the sub line portion S1 via the ring conductor R, and a capacitor is formed between the main line portion M3 and the sub line portion S3 via the ring conductor R. That is, capacitors are formed between the main line M and the sub line S. As a result, the capacitive coupling between the main line M and the sub line S is enhanced, thereby increasing the degree of coupling between the main line M and the sub line S.

In the directional coupler 10a, the centers of the main line portions M1 and M3 and the centers of the sub line portions S1 and S3 are located within the region surrounded by the ring conductor R, as viewed from above. With this configuration, it is possible to reduce the amount of magnetic flux generated by the main line portions M1 and M3 and the sub line portions Si and S3 that is blocked by the ring conductor R.

The inventors of this application conducted the following computer simulations to verify the advantages obtained by the directional coupler 10a. The inventors fabricated, as a first model, a directional coupler obtained by removing the ring conductor R from the directional coupler 10a. The inventors also fabricated the directional coupler 10a as a second model. Then, the coupling characteristics and the isolation characteristics of the first and second models were calculated by using a computer. The coupling characteristics are represented by the ratio of the power of a high-frequency signal output from the outer electrode 14c (coupling port) to the power of a high-frequency signal input from the outer electrode 14a (input port). The isolation characteristics are represented by the ratio of the power of a high-frequency signal output from the outer electrode 14d (terminate port) to the power of a high-frequency signal output from the outer electrode 14a (input port). Then, the present inventors calculated a value by dividing the value of the isolation characteristics by the value of the coupling characteristics, as the degree of coupling.

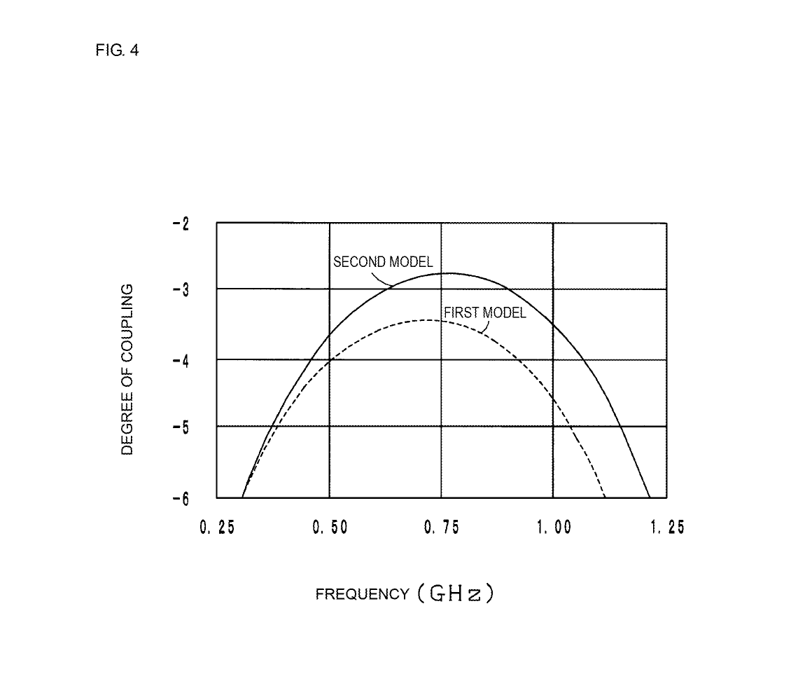

FIG. 4 is a graph illustrating the simulation results of the first model and the second model. In FIG. 4, the vertical axis indicates the degree of coupling (dB), and the horizontal axis indicates the frequency (GHz). In FIG. 4, as the vertical scale increases, the degree of coupling is higher, and as the vertical scale decreases, the degree of coupling is lower.

FIG. 4 shows that the degree of coupling of the second model is higher than that of the first model. It has thus been validated that, by the provision of the ring conductor R in the directional coupler 10a, the degree of coupling between the main line M and the sub line S is increased.

The main line M and the sub line S have substantially the same configuration, and are superposed on each other and coincide with each other, as viewed from above. Accordingly, the structure of the main line M and that of the sub line S are similar to each other, and thus, the electrical characteristics, such as the characteristic impedance, of the main line M and those of the sub line S can resemble each other. This makes it possible to reduce the phase difference between a signal output from the outer electrode 14b and a signal output from the outer electrode 14c. That is, the phase difference characteristics of the directional coupler 10a are enhanced.

Since the extended conductors 18a and 20a have substantially the same length, the resistance and phase change of the extended conductor 18a and those of the extended conductor 20a are substantially equal to each other. Accordingly, the electrical characteristics, such as the characteristic impedance, between the outer electrodes 14a and 14b and those between the outer electrodes 14c and 14d can resemble each other. The phase difference characteristics of the directional coupler 10a are also enhanced. The relationships between the extended conductors 18b and 20b can be explained in a similar manner, and thus, similar advantages can be obtained.

The extended conductors 18a, 18b, 20a, and 20b are formed in a linear shape. Accordingly, they can be connected to the outer electrodes with the shortest distance. Thus, the resistance of the extended conductors 18a, 18b, 20a, and 20b can be reduced to a small level, thereby suppressing unwanted magnetic coupling or capacitive coupling. As a result, the insertion loss of the directional coupler 10a can be reduced.

In the directional coupler 10a, the capacitor C1 is disposed between the outer electrode 14a and the outer electrodes 14e through 14j, the capacitor C2 is disposed between the outer electrode 14b and the outer electrodes 14e through 14j, the capacitor C3 is disposed between the outer electrode 14c and the outer electrodes 14e through 14j, and the capacitor C4 is disposed between the outer electrode 14d and the outer electrodes 14e through 14j. With this configuration, by changing the capacitance values of the capacitors C1 through C4, the characteristic impedance between the outer electrodes 14a and 14b and that between the outer electrodes 14c and 14d can be adjusted. Thus, the characteristic impedance between the outer electrodes 14a and 14b and that between the outer electrodes 14c and 14d can resemble each other, thereby enhancing the phase difference characteristics of the directional coupler 10a.

The ground conductor 22 is located on a higher level than the main line M, the sub line S, and the extended conductors 18a, 18b, 20a, and 20b. With this arrangement, the noise input from the top side of the directional coupler 10a can be absorbed by the ground conductor 22, thereby reducing the input and output of the noise into and from the main line M, the sub line S, and the extended conductors 18a, 18b, 20a, and 20b.

The ground conductor 24 is located on a lower level than the main line M, the sub line S, and the extended conductors 18a, 18b, 20a, and 20b. With this arrangement, the noise input from the bottom side of the directional coupler 10a can be absorbed by the ground conductor 24, thereby reducing the input and output of the noise into and from the main line M, the sub line S, and the extended conductors 18a, 18b, 20a, and 20b.

The ground conductor 24 is also disposed between the capacitor conductors 26a through 26d and the main line M, the sub line S, and the extended conductors 18a, 18b, 20a, and 20b. This makes it possible to suppress the formation of an unwanted capacitor between the capacitor conductors 26a through 26d and the main line M, the sub line S, and the extended conductors 18a, 18b, 20a, and 20b.

### Second Embodiment

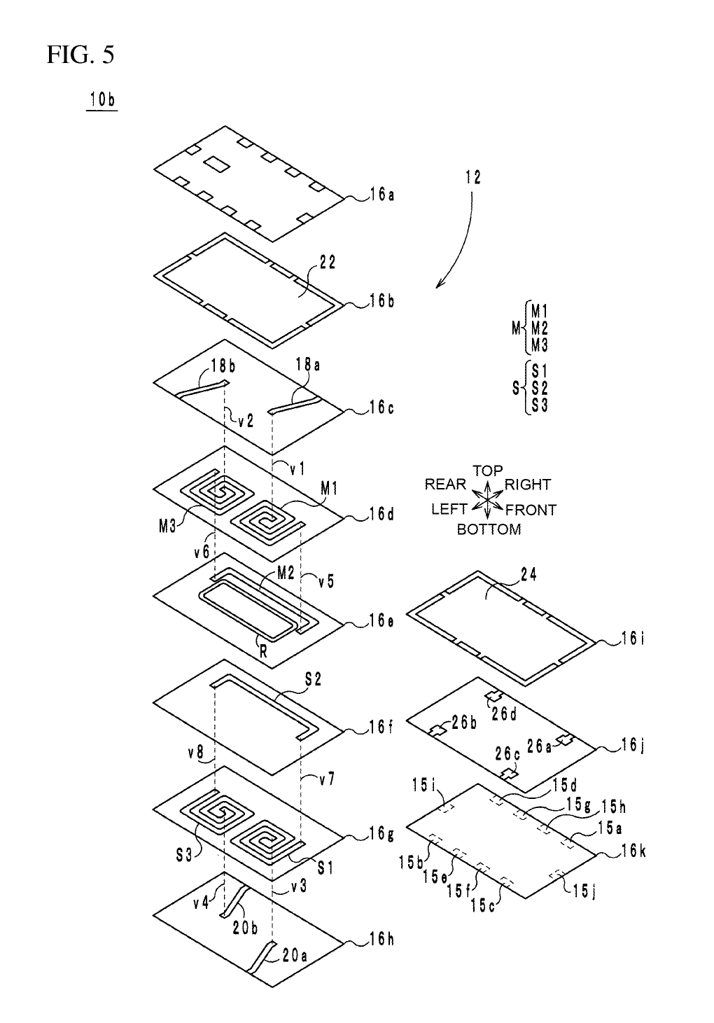

A directional coupler 10b according to a second embodiment will be described below with reference to FIG. 5. FIG. 5 is an exploded perspective view of a multilayer body 12 of the directional coupler 10b. As the external perspective view of the directional coupler 10b, FIG. 2 will be used.

The directional coupler 10b is different from the directional coupler 10a in that the intermediate line portion M2 is located at a different position from that of the main line portions M1 and M3 in the top-bottom direction and in that the intermediate line portion S2 is located at a different position from that of the sub line portions S1 and S3 in the top-bottom direction. More specifically, the main line portions M1 and M3 are disposed on the front side of the dielectric layer 16d, while the intermediate line portion M2 is disposed on the front side of the dielectric layer 16e. The sub line portions S1 and S3 are disposed on the front side of the dielectric layer 16g, while the intermediate line portion S2 is disposed on the front side of the dielectric layer 16f.

A via-hole conductor v5 passes through the dielectric layer 16d in the top-bottom direction and connects the downstream end of the main line portion M1 and the front end portion of the intermediate line portion M2. A via-hole conductor v6 passes through the dielectric layer 16d in the top-bottom direction and connects the upstream end of the main line portion M3 and the rear end portion of the intermediate line portion M2.

A via-hole conductor v7 passes through the dielectric layer 16f in the top-bottom direction and connects the downstream end of the sub line portion S1 and the front end portion of the intermediate line portion S2. A via-hole conductor v8 passes through the dielectric layer 16f in the top-bottom direction and connects the upstream end of the sub line portion S3 and the rear end portion of the intermediate line portion S2.

The ring conductor R is disposed on the front side of the dielectric layer 16e.

By the use of the directional coupler 10b configured as described above, advantages similar to those of the directional coupler 10a can be obtained.

### Third Embodiment

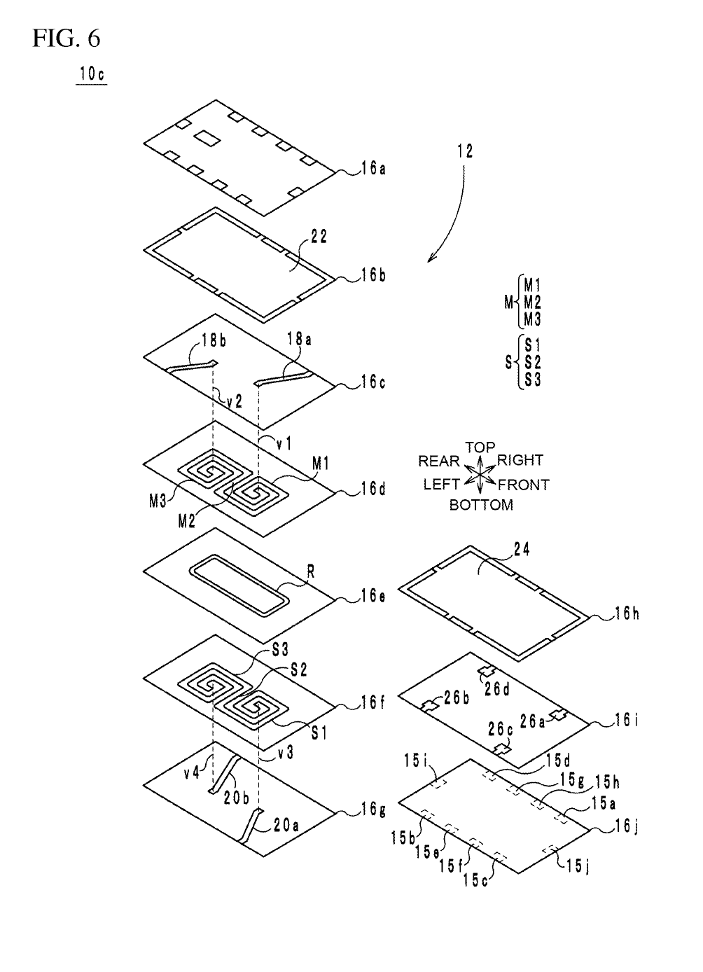

A directional coupler 10c according to a third embodiment will be described below with reference to FIG. 6. FIG. 6 is an exploded perspective view of a multilayer body 12 of the directional coupler 10c. As the external perspective view of the directional coupler 10c, FIG. 2 will be used.

The directional coupler 10c is different from the directional coupler 10a in the winding direction of the main line portion M1 and the sub line portion S1. In the directional coupler 10a, the main line portion M1 and the sub line portion S1 are formed in a spiral shape moving farther away from the center point while winding around the center point counterclockwise. In contrast, in the directional coupler 10c, the main line portion Ml and the sub line portion S1 are formed in a spiral shape moving farther away from the center point while winding around the center point clockwise.

By the use of the directional coupler 10c configured as described above, advantages similar to those of the directional coupler 10a can be obtained.

### Fourth Embodiment

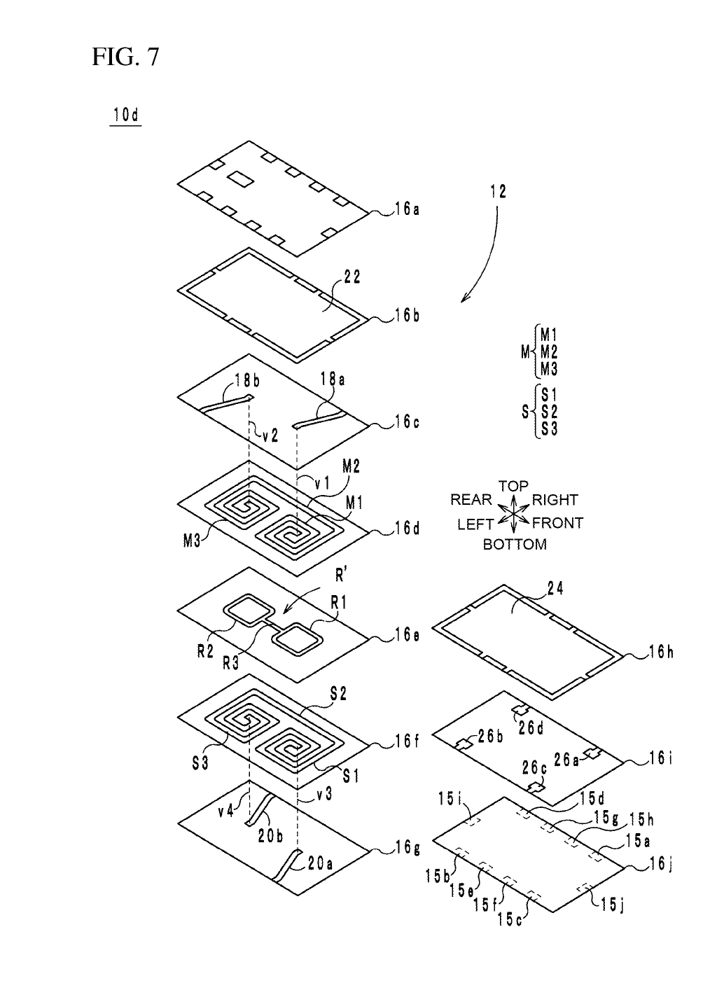

A directional coupler 10d according to a fourth embodiment will be described below with reference to FIG. 7. FIG. 7 is an exploded perspective view of a multilayer body 12 of the directional coupler 10d. As the external perspective view of the directional coupler 10d, FIG. 2 will be used.

The directional coupler 10d is different from the directional coupler 10a in the configuration of a ring conductor R′. The ring conductor R′ will be discussed more specifically. The ring conductor R′ includes ring-like portions R1 and R2 and a connecting portion R3 which are integrally formed. The ring-like portion R1 is a conductor layer formed substantially in a square ring and is disposed on the front half of the front side of the dielectric layer 16e. The ring-like portion R2 is a conductor layer formed substantially in a square ring and is disposed on the rear half of the front side of the dielectric layer 16e. The connecting portion R3 is a conductor layer connecting the ring-like portions R1 and R2 and is disposed on the front side of the dielectric layer 16e.

The center of the main line portion M1 and the center of the sub line portion S1 are located within a region surrounded by the ring-like portion R1, as viewed from above. The center of the main line portion M3 and the center of the sub line portion S3 are located within a region surrounded by the ring-like portion R2, as viewed from above.

By the use of the directional coupler 10d configured as described above, advantages similar to those of the directional coupler 10a can be obtained.

### Fifth Embodiment

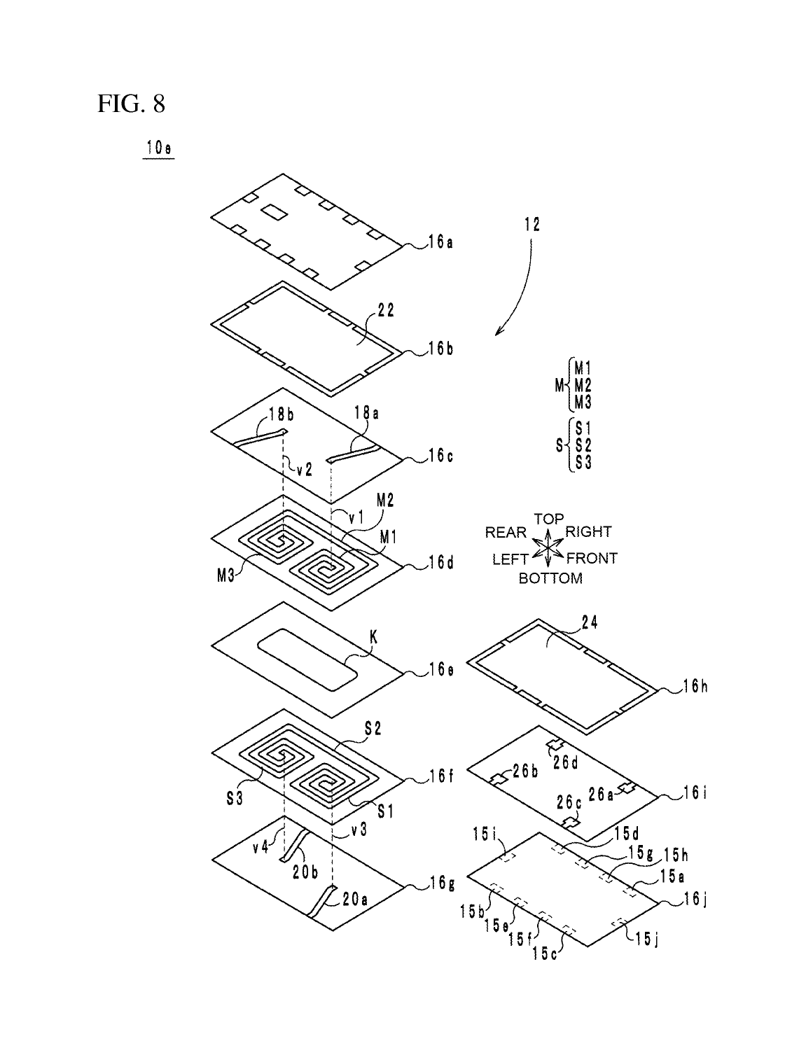

A directional coupler 10e according to a fifth embodiment will be described below with reference to FIG. 8. FIG. 8 is an exploded perspective view of a multilayer body 12 of the directional coupler 10e. As the external perspective view of the directional coupler 10e, FIG. 2 will be used.

The directional coupler 10e is different from the directional coupler 10a in that a coupling conductor K is used instead of the ring conductor R. The coupling conductor K will be described more specifically. The coupling conductor K is a conductor layer formed substantially in a rectangular shape and is disposed on the front side of the dielectric layer 16e. The coupling conductor K is superposed on the main line portions M1 and M3 and the sub line portions S1 and S3, as viewed from above.

By the use of the directional coupler 10e configured as described above, advantages similar to those of the directional coupler 10a can be obtained.

### Other Embodiments

The present disclosure is not restricted to the directional couplers 10a through 10e of the first through fifth embodiments, and modifications may be made within the spirit of the disclosure.

The configurations of the directional couplers 10a through 10e may be combined with each other.

In the directional coupler 10b of the second embodiment, the intermediate line portions M2 and S2 may be located at the same position in the top-bottom direction. That is, the intermediate line portions M2 and S2 may be located on the same dielectric layer. In this case, as viewed from above, the intermediate line portions M2 and S2 are displaced from each other, instead of being superposed on each other as in the directional coupler 10d.

In the directional coupler 10b of the second embodiment, the position in the front-rear direction and/or the position in the right-left direction of the intermediate line portion M2 or S2 on the insulating layer may be changed so as to adjust the distance between the intermediate line portion M2 and the intermediate line portion S2. As a result, fine-adjustments may be made to the degree of coupling between the main line M and the sub line S.

In the directional couplers 10a through 10e, the width of the intermediate line portion M2 and that of the intermediate line portion S2 may be different from each other. Similarly, the width of the main line portion M1 and that of the sub line portion S1 may be different from each other, and the width of the main line portion M3 and that of the sub line portion S3 may be different from each other. In this manner, by changing the widths of the main line portions M1 and M3 and the intermediate line portion M2 and the widths of the sub line portions S1 and S3 and the intermediate line portion S2, the characteristic impedance of the main line M and that of the sub line S can be adjusted.

In the directional couplers 10a through 10e, it is preferable that the portions of the outer electrodes 14a through 14d bent to the bottom surface (hereinafter such portions will be referred to as “bent portions 15a through 15d” (see FIG. 3)) be smaller than the capacitor conductors 26a through 26d and be respectively contained within the capacitor conductors 26a through 26d (not extend to the outside of the capacitor conductors 26a through 26d), as viewed from above. With this arrangement, it is possible to suppress the formation of an unwanted capacitor between the bent portions 15a through 15d and the ground conductor 24.

The main line portions M1 and M3 may be disposed on different dielectric layers. The sub line portions S1 and S3 may be disposed on different dielectric layers. The configuration of the main line portion M1 and that of the sub line portion S1 may be different from each other. The configuration of the intermediate line portion M2 and that of the intermediate line portion S2 may be different from each other. The configuration of the main line portion M3 and that of the sub line portion S3 may be different from each other.

In the directional couplers 10a through 10e, the ring conductor R and the coupling conductor K may be superposed only on the main line portion M1 and the sub line portion S3, as viewed from above. That is, it is not always necessary that the ring conductor R and the coupling conductor K be superposed on the main line portion M3 and the sub line portion S1, as viewed from above. Alternatively, the ring conductor R and the coupling conductor K may be superposed only on the main line portion M3 and the sub line portion S1, as viewed from above. That is, it is not always necessary that the ring conductor R and the coupling conductor K be superposed on the main line portion M1 and the sub line portion S3, as viewed from above.

In the directional couplers 10a through 10e, the position of the main line portion M3 and the position of the sub line portion S3 may be swapped. In the directional coupler 10a, for example, the sub line portion S1 and the main line portion M3 may be disposed on the front side of the dielectric layer 16f, while the main line portion M1 and the sub line portion S3 may be disposed on the front side of the dielectric layer 16d. In this case, the ring conductor R may be disposed on a lower level than the sub line portion S1 and the main line portion M3 or on a higher level than the main line portion M1 and the sub line portion S3.

As described above, preferred embodiments of the present disclosure are suitably used for a directional coupler, and are particularly useful in that it is possible to increase the degree of coupling between a main line and a sub line of a directional coupler.

While preferred embodiments of the disclosure have been described above, it is to be understood that variations and modifications will be apparent to those skilled in the art without departing from the scope and spirit of the disclosure. The scope of the invention, therefore, is to be determined solely by the following claims.

What is claimed is:

1. A directional coupler comprising:
a main line including first and second main line portions formed substantially in a spiral shape, as viewed from a first direction, the second main line portion being positioned in a second direction which is perpendicular to the first direction, as viewed from the first direction;
a sub line including first and second sub line portions formed substantially in a spiral shape, as viewed from the first direction, the first and second sub line portions being electromagnetically coupled with the first and second main line portions, respectively, the second sub line portion being positioned in the second direction, as viewed from the first direction; and
a parasitic element that is superposed on the first main line portion and the second sub line portion, as viewed from the first direction.

2. The directional coupler according to claim 1, wherein the parasitic element is superposed on the first and second main line portions and the first and second sub line portions, as viewed from the first direction.

3. The directional coupler according to claim 2, wherein:
the parasitic element is formed substantially in a ring-like shape, as viewed from the first direction; and
a center of the first main line portion, a center of the second main line portion, a center of the first sub line portion, and a center of the second sub line portion are located within a region surrounded by the parasitic element, as viewed from the first direction.

4. The directional coupler according to claim 2, wherein:
the parasitic element includes first and second ring-like portions formed substantially in a ring-like shape, as viewed from the first direction, and a connecting portion connecting the first and second ring-like portions;
a center of the first main line portion and a center of the first sub line portion are located within a region surrounded by the first ring-like portion, as viewed from the first direction; and
a center of the second main line portion and a center of the second sub line portion are located within a region surrounded by the second ring-like portion, as viewed from the first direction.

5. The directional coupler according to claim 1, wherein:
the first sub line portion is positioned at one side of the first direction;
the second sub line portion is positioned at one side of the first direction; and
the parasitic element is positioned between the first main line portion and the first sub line portion and between the second main line portion and the second sub line portion in the first direction.

6. The directional coupler according to claim 1, wherein the parasitic element includes a plurality of components which are integrally formed.

7. The directional coupler according to claim 1, wherein:
the second main line portion is positioned adjacent to the first main line portion in the second direction; and
the second sub line portion is positioned adjacent to the first sub line portion in the second direction.

8. The directional coupler according to claim 5, wherein:
the first sub line portion is positioned at one side of the first direction and the first main line portion is positioned at the other side of the first direction; and
the second sub line portion is positioned at one side of the first direction and the second main line portion is positioned at the other side of the first direction.

9. The directional coupler according to claim 2, wherein:
the first sub line portion is positioned at one side of the first direction;
the second sub line portion is positioned at one side of the first direction; and
the parasitic element is positioned between the first main line portion and the first sub line portion and between the second main line portion and the second sub line portion in the first direction.

10. The directional coupler according to claim 3, wherein:
the first sub line portion is positioned at one side of the first direction;
the second sub line portion is positioned at one side of the first direction; and
the parasitic element is positioned between the first main line portion and the first sub line portion and between the second main line portion and the second sub line portion in the first direction.

11. The directional coupler according to claim 4, wherein:
the first sub line portion is positioned at one side of the first direction;
the second sub line portion is positioned at one side of the first direction; and
the parasitic element is positioned between the first main line portion and the first sub line portion and between the second main line portion and the second sub line portion in the first direction.

12. The directional coupler according to claim 2, wherein the parasitic element includes a plurality of components which are integrally formed.

13. The directional coupler according to claim 3, wherein the parasitic element includes a plurality of components which are integrally formed.

14. The directional coupler according to claim 4, wherein the parasitic element includes a plurality of components which are integrally formed.
